(19) United States
(12) Patent Application Publication
(10) Pub. No.: US 2017/0336700 A1
(43) Pub. Date: Nov. 23, 2017

(54) GIMBAL AND SHOOTING APPARATUS COMPRISING THE SAME

(71) Applicant: ZEROTECH (SHENZHEN) INTELLIGENCE ROBOT CO., LTD., Shenzhen (CN)

(72) Inventor: Gengpeng LIU, Beijing (CN)

(73) Assignee: ZEROTECH (SHENZHEN) INTELLIGENCE ROBOT CO., LTD., Shenzhen (CN)

(21) Appl. No.: 15/280,129

(22) Filed: Sep. 29, 2016

(30) Foreign Application Priority Data
May 17, 2016 (CN) 201620449932.9

(51) Int. Cl. G03B 17/56; F16M 11/18; G03B 15/00; F16M 11/12

(52) U.S. Cl. CPC G03B 17/561; G03B 17/566; F16M 11/12; F16M 11/18; G03B 15/006

(57) ABSTRACT

A gimbal and a shooting apparatus are provided. The gimbal includes a motor and an imaging module, the gimbal further includes a case of the imaging module, the imaging module is received in the case, and the imaging module is connected with the motor through the case so that the case serves as a connection member.

### BACKGROUND

Embodiments of the present disclosure relate to a gimbal and a shooting apparatus comprising the same.

Gimbal is generally provided on a movable apparatus, such as an aircraft, a handhold apparatus and the like. As the movable apparatus, such as the aircraft, the handhold apparatus and the like is gradually miniaturized, it is necessary that the gimbal is correspondingly developed towards miniaturization so that the gimbal is applicable to the miniaturized movable device. The gimbal is mounted with a camera to capture an image. The camera is generally a separate device and is detachably mounted on the gimbal through a connection component. A motor of the gimbal is rotated and brings the camera to move, so as to adjust the shooting angle of the camera.

However, as above described, the camera is the separate device and is connected with the gimbal through the connection component. In this case, the connection component for connecting the gimbal and the camera will increase the total weight, moment of inertia, and occupying space of the gimbal, which does not comply with the miniaturization and integration design of the gimbal.

### SUMMARY

According to embodiments of the disclosure, a gimbal including a motor and an imaging module is provided. The gimbal further includes a case of the imaging module, the imaging module is received in the case, and the imaging module is connected with the motor through the case so that the case serves as a connection member.

For example, the motor includes a stator and a rotor housing rotatably connected with the stator, and the imaging module is connected with the rotor housing through the case and is moved along with the rotor housing.

For example, the case includes a first connection member, and the first connection member is connected with the rotor housing.

For example, the first connection member is embedded into the rotor housing and is of interference fit with the rotor housing, or the first connection member is integrated with the rotor housing.

For example, the case further includes a second connection member, the first connection member has a first accommodation cavity, the second connection member has a second accommodation cavity, the second connection member is connected with the first connection member so that the first accommodation cavity and the second accommodation cavity are combined to form an accommodation cavity for accommodating the imaging module.

For example, a side wall of the first connection member is disposed with a first opening, a side wall of the second connection member is disposed with a second opening at a position corresponding to the first opening, and the first opening and the second opening are combined to form a limiting hole for a lens of the imaging module to protrude.

For example, the limiting hole fixes the lens of the imaging module therein.

For example, an inner wall of the first connection member adjacent to the rotor housing defines a friction face, an end of the imaging module adjacent to the rotor housing defines an abutting face, and the abutting face is abutted against the friction face.

For example, the case further includes a counterweight component for adjusting a gravity center of the imaging module.

For example, the counterweight component is a counterweight block received in the case.

For example, a side wall of the first connection member is disposed with a first receiving hole disposed at a position opposite to the first opening and extended along an axial direction of the first connection member, a side wall of the second connection member is disposed with a second receiving hole disposed at a position corresponding to the first receiving hole and extended along an axial direction of the second connection member, and the first receiving hole and the second receiving hole are combined to form a counterweight hole and the counterweight block is received in the counterweight hole.

For example, the first connection member is disposed with a first connection hole, the second connection member is disposed with a second connection hole at a position corresponding to the first connection hole, the first connection hole and the second connection hole are combined to form a connection hole and a connection structure is received in the connection hole.

For example, the gimbal further includes a pitch motor, a yaw motor and a roll motor. The motor is the pitch motor. An axis of the pitch motor, an axis of the roll motor and an axis of the yaw motor are perpendicular to each other, the pitch motor includes a pitch rotor housing and a pitch stator and the pitch rotor housing is rotatably connected with the pitch stator, the yaw motor includes a yaw rotor housing and a yaw stator and the yaw rotor housing is rotatably connected with the yaw stator, and the roll motor includes a roll rotor housing and a roll stator and the roll rotor housing is rotatably connected with the roll stator.

For example, the yaw stator is connected with the roll rotor housing through a first connection arm, the pitch motor and the imaging module are connected with a lower side of the yaw rotor housing.

For example, the gimbal further includes a first counterweight component and a second counterweight component. The second counterweight component is connected with the roll rotor housing through a second connection arm, the yaw motor and the second counterweight component are opposite to each other and are respectively disposed at opposite sides of the roll motor, the first counterweight component is disposed at an end of the case away from the pitch rotor housing, one end of the first counterweight component is fixedly connected with the yaw rotor housing and the other end of the first counterweight component is disposed with a rotation arm.

For example, the second counterweight component is disposed with an accommodation cavity and the rotation arm is extended into the accommodation cavity of the second counterweight component.

For example, the first connection arm and the second connection arm are disposed at opposite sides of the roll motor and are disposed on a same straight line.

According to the embodiments of the disclosure, a shooting apparatus is provided, and the shooting apparatus includes the gimbal as described above.

### BRIEF DESCRIPTION OF THE DRAWINGS

In order to more clearly describe the technical solution of the embodiments of the present disclosure, the accompanying drawings for the embodiments will be briefly described, it should be understood that the accompanying drawings only illustrate some embodiments of the present disclosure, and are not intended to limit the present disclosure. To the person skilled in the art, other relevant drawings can be conceived according to these accompanying drawings without any creative labor.

FIG. 1 is a schematic view illustrating a gimbal according to embodiments of the present disclosure;

FIG. 2 is an explored structural schematic view illustrating the gimbal according to the embodiments of the present disclosure viewed from a side view angle;

FIG. 3 is an explored structural schematic view illustrating the gimbal according to the embodiments of the present disclosure viewed from another view angle;

FIG. 4 is a schematic view illustrating another gimbal according to the embodiments of the present disclosure; and

FIG. 5 is an explored structural schematic view illustrating the gimbal of FIG. 4.

### DESCRIPTION OF THE EMBODIMENTS

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Generally, the components of the embodiments of the present disclosure as shown and described in the accompanying drawings can be arranged and designed in various configurations.

The detail descriptions on the embodiments of the present disclosure provided in the accompanying drawings are not intended to limit the scope of the disclosure, but only indicate a part of the embodiments of the present disclosure. Based on the described embodiments herein, those skilled in the art can obtain other embodiment(s), without any inventive work, which should be within the scope of the disclosure.

It is to be noted that, similar symbols and letters are used to indicate the similar items throughout the drawings, and therefore, once an item has been defined in one drawing, then the item does not need to be further defined and explained in the subsequent drawings.

It is appreciated that, the location or position relationship indicated by the terms “upper”, “lower”, “inner”, “outer” and the like, as used herein, is based on the location or position relationship shown in the accompanying drawings, or the location or position relationship normally placed when the product according to the embodiments of the disclosure is being used, or the location or position relationship conventionally understood by the person skilled in the art, and serves merely for the purpose of facilitating the description of the present disclosure and simplify the description, but does not indicate or imply that the indicated device or member must have the specific location or position and/or must be constructed and operated in a specific location, and therefore, should not be construed as limitation on the present disclosure.

In addition, the terms “first”, “second” and the like, as used herein, merely serve for distinguishing, but should not be understood as indicating or implying relative significance.

In the description of the present disclosure, it is also to be noted that unless otherwise described or defined explicitly, the terms “provide”, “connect” and the like should be understood in their broad sense; for example, it can be a fixedly connection, a detachable connection or integrally connection; can be a mechanical connection or an electric connection; can be a direct connection or a indirect connection via a intervene medium; or can be communication between inner portions of two members. The specific meaning of the above terms in the present disclosure can be understood by the person skilled in the art according to the specific situation.

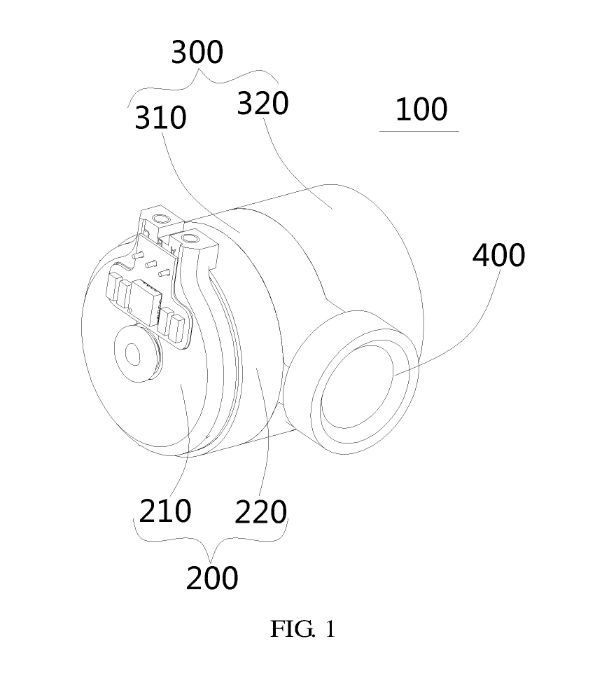

With reference to FIG. 1, embodiments of the present disclosure provide a gimbal 100, the gimbal 100 includes a motor 200, an imaging module 400, and a case 300 of the imaging module 400, the imaging module 400 is received in the case 300, and the imaging module 400 is connected with the motor 200 through the case 300 so that the case 300 servers as a connection member.

For example, the motor 200 includes a stator 210 and a rotor housing 220 rotatably connected with the stator 210, and the imaging module 400 is connected with the rotor housing 220 through the case 300 and is moved along with the rotor housing 220.

It should be appreciated that, the case 300 is an accommodation component for accommodating the imaging module 400, and at the same time, the imaging module case 300 further serves as the connection member for connecting the imaging module 400 with the motor 200 (more specifically, the rotor housing 220 of the motor 200). Thus, the accommodation component for accommodating the imaging module 400 and the connection member for connecting the imaging module 400 and the motor (more specifically, the rotor housing 220 of the motor 200) are integrated into one piece; accordingly, a separate connection structure is avoided, design cost is effectively reduced, and the volume of the gimbal 100 is effectively reduced, and the weight of the gimbal 100 is also decreased, which is well suitable for the miniaturization and integration design of the gimbal 100.

In the gimbal 100 according to the embodiments of the present disclosure, in order to better connect the imaging module 400 and the rotor housing 220 and better dispose the imaging module 400, for example, the case 300 has the following structure.

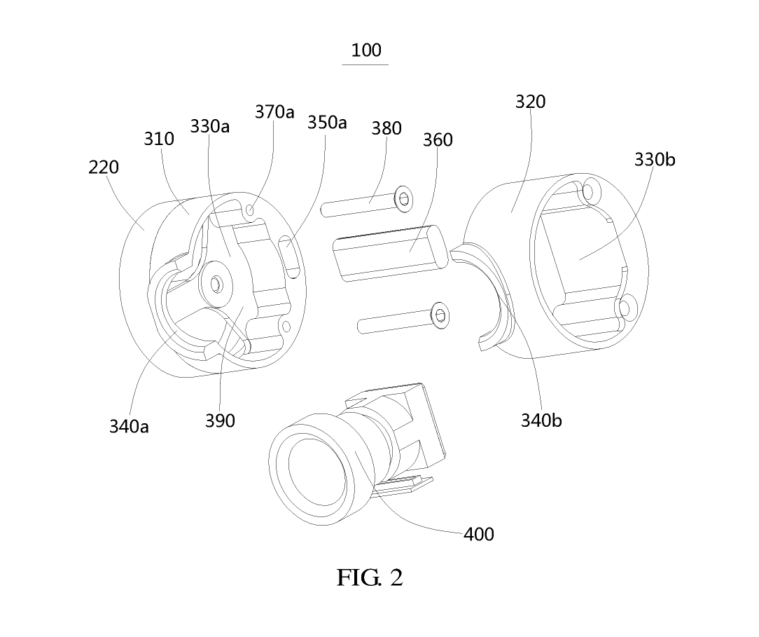

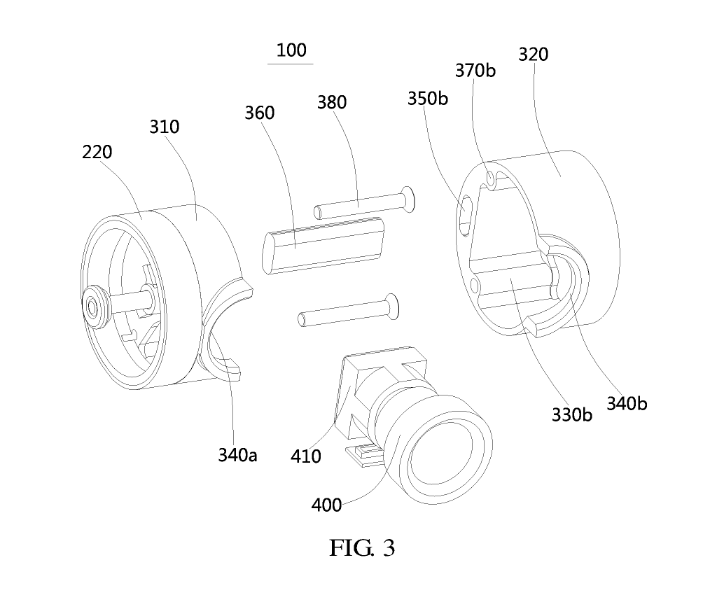

With reference to FIG. 2 and FIG. 3, the case 300 includes a first connection member 310, and the first connection member 310 is connected with the rotor housing 220. The first connection member 310 is connected with the rotor housing 220 in various ways.

For example, the first connection member 310 is embedded into the rotor housing 220 and is of interference fit with the rotor housing 220. Thus, the first connection member 310 is easily disposed on the basis of the structure of the rotor housing 220 of the motor 200. For example, the first connection member 210 is integrated with the rotor housing 220, that is, the first connection member 310 is a part of the rotor housing 220. Of course, the first connection member 310 may be connected with the rotor housing 220 in other ways.

In consideration of the processing convenience, the first connection member 310 is embedded into the rotor housing 220 and is of interference fit with the rotor housing 220. In this case, for example, the first connection member 310 is an insert of the rotor housing 220. For example, the insert of the rotor housing 220 is formed from a light material having small density; furthermore, for example, the insert of the rotor housing 220 is formed from aluminum; that is to say, the insert of the rotor housing 220 is an aluminum insert.

For example, in order to better receive the imaging module 400 in the case 300, the case 300 further includes a second connection member 320 fitted with the first connection member 310. The first connection member 310 has a first accommodation cavity 330a, the second connection member 320 has a second accommodation cavity 330b, the second connection member 320 is connected with the first connection member 310, and the first accommodation cavity 330a and the second accommodation cavity 330b are combined to form an accommodation cavity for accommodating the imaging module 400.

It should be appreciated that, in the case that the first connection member 310 is connected with the second connection member 320, the imaging module 400 is accommodated in the accommodation cavity. For example, a part of the imaging module 400 is accommodated in the first accommodation cavity 330a and the other part of the imaging module 400 is accommodated in the second accommodation cavity 330b.

For example, the second connection member 320 is a cover which is capable of tightly pressing the imaging module 400 between the first connection member 310 and the second connection member 320 and ensuring the reliable fixing of the imaging module 400.

For example, an end of the second connection member 320 away from the first connection member 310 is not closed, so that other components of the gimbal (e.g. a counterweight component) is easily mounted

For example, the first connection member 310 and the second connection member 320 are both in cylindrical shape. For example, a side wall of the first connection member 310 is disposed with a first opening 340a, and a side wall of the second connection member 320 is disposed with a second opening 340b at a position corresponding to the first opening 340a. The first opening 340a and the second opening 340b are combined to form a limiting hole for a lens of the imaging module 400 to protrude. For example, the first opening 340a is an arc-shaped opening. For example, the second opening 340b is an arc-shaped opening.

For example, the first opening 340a is communicated with the first accommodation cavity 330a, and the second opening 340b is communicated with the second accommodation cavity 330b. A rear end of the imaging module 400 is fixedly received in the accommodation cavity, and the lens at a front end of the imaging module 400 is capable of protruding outside the limiting hole.

For example, the shape of the first opening 340a and the shape of the second opening 340b are matched with a left portion and a right portion of the lens of the imaging module 400, respectively. For example, the first opening 340a and the second opening 340b are in a semi-circle shape, and are combined to form a circle. For example, the limiting hole formed by the first opening 340a of the first connection member 310 and the second opening 340b of the second connection member 320 fixes the lens of the imaging module 400 therein, so that the lens is prevented from swinging, shaking or rotating and the imaging module 400 is fixed more stably. In this case, for example, the limiting hole has a size substantially identical with the size of a portion of the lens fixed in the limiting hole.

For example, the size of the limiting hole is disposed to be larger than the size of the lens so that the lens is capable of protruding from and retracting into the accommodation cavity. In this case, the lens is retracted into the accommodation cavity in the case that imaging module 400 does not take an image, so as to protect the lens.

For example, an inner wall of the first connection member 310 adjacent to the rotor housing 220 defines a friction face 390, and an end of the imaging module 400 adjacent to the rotor housing 220 defines an abutting face 310, the abutting face 310 is abutted against the friction face 390. In this way, in the case that the imaging module 400 is received in the first connection member 310 and the second connection member 320, the abutting face 410 is abutted against the friction face 390, thus the friction face 390 prevents the imaging module 400 from rotating and ensures the imaging module 400 to be more reliably fixed. For example, the imaging module 400 is prevented from rotating by a friction force between the friction face 390 and the abutting face 410. For example, a recess is disposed on the friction face 390 and has a shape matched with the end of the imaging module 400 adjacent to the rotor housing 220. Thus, in the case that the imaging module 400 is received in the first connection member 310 and the second connection member 320, the end of the imaging module 400 adjacent to the rotor housing 220 is inserted into the recess, to better prevent the imaging module 400 from rotating.

The inventor of the present disclosure found that, in the case that the lens of the imaging module 400 is protruded from the limiting hole, the imaging module 400 possibly loses balance and a gravity center of the imaging module 400 possibly is caused to be largely displaced so that the shooting effect is adversely influenced. In order to solve this problem, in the embodiments of the present disclosure, a counterweight component for adjusting the gravity center of the imaging module 400 is disposed on the case 300. By employing the counterweight component, the gravity center of the imaging module 400 is adjusted and it is ensured that the gravity center is kept in a very small displacement range, and thus the shooting effect is guaranteed.

For example, in the embodiments of the present disclosure, the counterweight component is a counterweight block 360, and the counterweight block 360 for example is a copper block. In order to better mount the counterweight block 360, for example, a side wall of the first connection member 310 is disposed with a first receiving hole 350a disposed at a position opposite to the first opening 340a and extended along an axial direction of the first connection member 310, a side wall of the second connection member 320 is disposed with a second receiving hole 350b disposed at a position corresponding to the first receiving hole 350a and extended along an axial direction of the second connection member 320, and the first receiving hole 350a and the second receiving hole 350b are combined to form a counterweight hole and the counterweight block 360 is received in the counterweight hole.

For example, the side wall of the first connection member 310 in which the first receiving hole 350a is disposed is thickened (that is, has a relative large thickness), so as to facilitate the disposition of the first receiving hole 350a. Similarly, the side wall of the second connection member 320 in which the second receiving hole 350b is disposed is thickened, that is, has a relative large thickness. Moreover, the thickened side walls of the first connection member 310 and the second connection member 320 form a fitting face to fit with a surface at the rear end of the imaging module 400, so that the imaging module 400 is more reliably fixed.

It should be understood that, the counterweight component in the embodiments of the present disclosure is optional to be the counterweight block 360; and in other embodiments of the present disclosure, the counterweight block 360 may be omitted. The structure of the case 300 is adjusted according to the mounting position of the imaging module 400 in the front and back directions, that is, other type of counterweight component may be disposed as necessary, for example, the gravity center of the imaging module 400 is adjusted by only adjusting the structures of the first connection member 310 and the second connection member 320.

For example, in order to more reliably and tightly connect the first connection member 310 and the second connection member 320, in the embodiments of the present disclosure, the first connection member 310 is disposed with a first connection hole 370a, the second connection member 320 is disposed with a second connection hole 370b at a position corresponding to the first connection hole 370a, and the first connection hole 370a and the second connection hole 370b are combined to form a connection hole and a connection structure 380 is received in the connection hole 370b. For example, there are two first connection holes 370a and two second connection holes 370b, the two first connection holes 370a are respectively disposed at opposite sides of the first receiving hole 350a, and the two second connection holes 370b are respectively disposed at opposite sides of the second receiving hole 350b.

With reference to FIG. 1 to FIG. 3, in the gimbal 100 according to the embodiments of the present disclosure, the imaging module 400 is brought into rotation through the case 300 in the case that the rotor housing 220 is rotated; the case 300 simultaneously serves as the connection member, that is to say, the case 300 not only is the accommodation structure for accommodating the imaging module 400 but also is the connection member for connecting the imaging module 200 with the rotor housing 220. Thus, a separate connection structure is avoided, the design cost is effectively decreased, the volume of the gimbal 100 is effectively reduced, and the weight of the gimbal 100 is decreased, which is well suitable for the miniaturization and integration design of the gimbal 100.

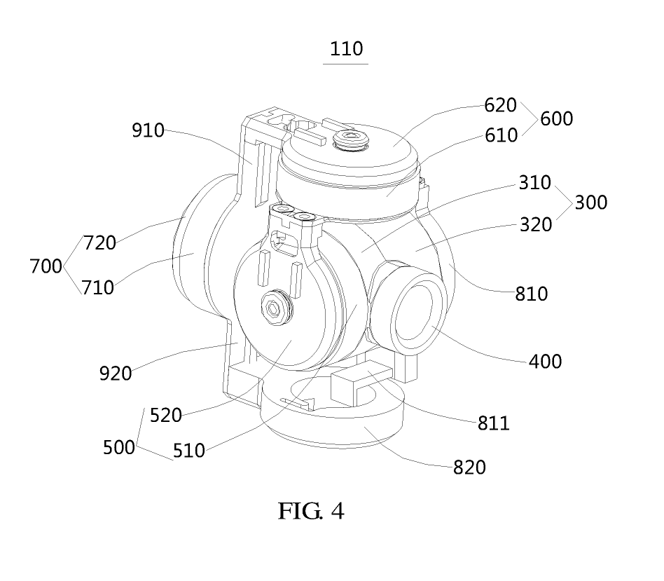

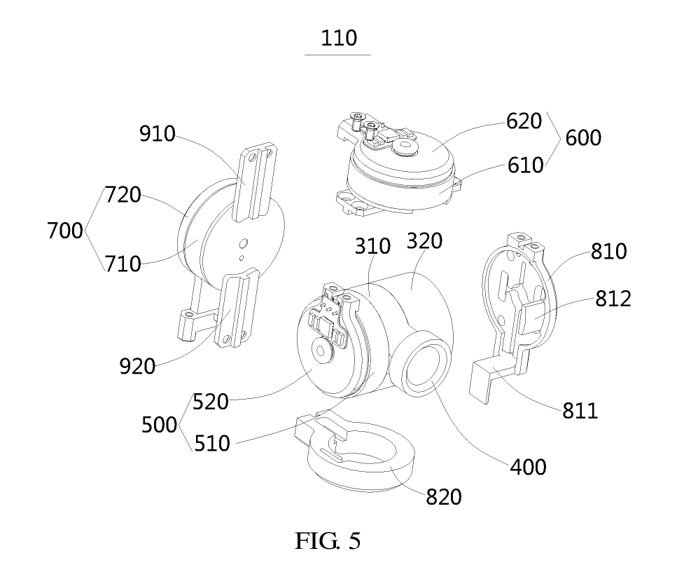

With reference to FIG. 4 and FIG. 5, for example, the gimbal 110 according to the embodiments of the present disclosure includes a pitch motor 500, a yaw motor 600, a roll motor 700, a first counterweight component 810, a second counterweight component 820, and the imaging module 400. An axis of the pitch motor 500, an axis of the roll motor 700 and an axis of the yaw motor 600 are perpendicular to each other.

For example, the pitch motor 520 includes a pitch rotor housing 510 and a pitch stator 520, the pitch rotor housing 510 is rotatable with respect to the pitch stator 520. For example, the pitch motor 500 is the above-described motor 200; that is, the gimbal 110 according to the embodiments further includes the case 300 of the imaging module 400, the imaging module 400 is received in the case 300, and the imaging module 400 is moved along with the pitch rotor housing 510 through the case 300.

For example, with reference to FIG. 4 and FIG. 5, the yaw motor 600 includes a yaw rotor housing 610 and a yaw stator 620, the yaw rotor housing 610 is rotatable with respect to the yaw stator 620. The roll motor 700 includes a roll rotor housing 710 and a roll stator 720, the roll rotor housing 710 is rotatable with respect to the roll stator 720.

For example, the yaw stator 620 is connected with the roll rotor housing 710 through a first connection arm 910, and the second counterweight component 820 is connected with the roll rotor housing 710 through a second connection arm 920. The yaw motor 600 and the second counterweight component 820 are opposite to each other and are respectively disposed at opposite sides of the roll motor 700. For example, the first connection arm 910 and the second connection arm 920 are disposed on a same straight line. For example, the second counterweight component 820 is in circular disk shape, and is disposed with an accommodation cavity therein.

The pitch motor 500 and the case 300 are disposed between the yaw motor 600 and the second counterweight component 820. The pitch motor 500 and the case 300 are connected with a lower side of the yaw rotor housing 610. The first counterweight component 810 is disposed at an end of the case 300 away from the pitch rotor housing 510 (more specifically, the first counterweight component 810 is disposed at an end of the second connection member 320 away from the pitch rotor housing 510). For example, the first counterweight component 810 is in circular disk shape, one end thereof is fixedly connected with the yaw rotor housing 610, and the other end thereof is disposed with a rotation arm 811. For example, the rotation arm 811 is in an L shape, and an end thereof is extended into the accommodation cavity of the second counterweight component 820. A side of the first counterweight component 810 adjacent to the second connection member 320 is disposed with a clamping block 812. The first counterweight component 810 is disposed to cover an end of the second connection member 320 away from the imaging module 400, and the clamping block 812 is disposed into the second accommodation cavity 330b of the second connection member 320.

The first counterweight component 810 and the second counterweight component 820 not only are used as the counterweight structures of the gimbal, but also are used as the structures for winding a FPC (Flexible Printed Circuit) cable of the gimbal, and the pitch motor 500, the roll motor 700 and the yaw motor 600 of the gimbal 100 are connected with a controller through the FPC.

In the case that the pitch motor 500 is in operation, the pitch rotor housing 510 is rotated with respect to the pitch stator 520, the pitch rotor housing 510 drives the first connection member 310 to rotate around the axis of the pitch motor 500 and thus drives the imaging module 400 to rotate around the axis of the pitch motor 500, and at the same time, the second connection member 320 is rotated along with the first connection member 310. Under the driving of the pitch rotor housing 510, the first connection member 310 and the second connection member 320 are rotated with respect to the first counterweight component 810. In the case that the roll motor 700 is in operation, the roll rotor housing 710 is rotated with respect to the roll stator 720, the roll rotor housing 710 drives the first connection arm 910 and the second connection arm 920 to rotate in a same direction (that is, the roll rotor housing 710 drives the first connection arm 910 and the second connection arm 920 to simultaneously rotate clockwise or to simultaneously rotate anticlockwise), and thus drives the yaw motor 600 and the second counterweight component 820 to rotate around the axis of the roll motor 700 in a same direction. In the case that the yaw motor 600 is in operation, the yaw rotor housing 610 is rotated with respect to the yaw stator 620, the yaw rotor housing 610 drives the pitch motor 500 and the first counterweight component 810 to rotate around the axis of the yaw motor 600 in a same direction, and the case 300 is rotated around the axis of the yaw motor 600 along with the pitch motor 500. In addition, the rotation arm 811 of the first counterweight component 810 is rotated in the accommodation cavity of the second counterweight component 820.

It should be understood that, the first counterweight component 810 and the second counterweight component 820 both may be omitted. By adjusting the pitch motor 500 and the case 300 to move in upward and downward direction, and/or forward and backward direction, and/or leftward and rightward direction, the gravity center of the gimbal is adjusted even the first counterweight component 810 and the second counterweight component 820 are omitted, so that the gimbal 100 becomes lighter and samller. In addition, by appropriately lengthening or shortening lengths of the arms of the motors (e.g. the first connection arm 910, the second connection arm 920, and so on), the gravity center of the gimbal 110 on three axes is adjusted as well.

In the gimbal 110 according to the embodiments of the present disclosure, by providing the first counterweight component 810 and the second counterweight component 820, the problem of winding the FPC cable is solved; and due to the combination design of the pitch motor 500, the roll motor 700, the yaw motor 600, the case 300, the imaging module 400, the counterweight block 360, the first counterweight component 810 and the second counterweight component 820 of the gimbal 110, the weight of the gimbal 110 is reduced and the occupying space of the gimbal 100 is decreased, so that the miniaturization and integration of the gimbal 100 is achieved.

The gimbal shown in FIG. 1 to FIG. 3 is a uni-axial gimbal, and the gimbal shown in FIG. 4 to FIG. 5 is a tri-axial gimbal. In addition, the gimbal according to the embodiments of the present disclosure for example is a bi-axial gimbal including two motors; and in this case, the imaging module 400 is connected with one of the two motors through the case 300.

In FIG. 4 to FIG. 5, the imaging module 400 is connected with the pitch motor 500 through the case 300. In addition, in the embodiments of the present disclosure, the imaging module 400 for example is connected with the yaw motor 600 or the roll motor 700 through the case 300.

The embodiments of the present disclosure further provide a shooting apparatus comprising any one of the gimbals as above described. For example, the gimbal is detachably disposed on the shooting apparatus. For example, the shooting apparatus is a movable apparatus, such as an aircraft, a handhold apparatus and the like. As for the shooting apparatus according to the embodiments of the present disclosure, the design cost is decreased, the volume of the gimbal is effectively reduced, the weight of the gimbal is decreased, and the shooting apparatus achieves miniaturization and integration.

What has been described above is only some embodiments of the present disclosure and is not intended to limit the present disclosure, and many modifications and variations can be easily conceived by the person skilled in the art. All the modifications, equivalent substitutions and improvement made within the spirit and principle of the present disclosure should be covered by the protection scope of the present disclosure.

The present application claims the priority of a Chinese Patent Application No. 201620449932.9, filed on May 17, 2016, the disclosure of which is entirely incorporated herein by reference as a part of the present application.

1. A gimbal, comprising a motor and an imaging module,
wherein the gimbal further comprises a case of the imaging module, the imaging module is received in the case, and the imaging module is connected with the motor through the case so that the case serves as a connection member,
wherein the motor comprises a stator and a rotor housing rotatably connected with the stator, and the imaging module is connected with the rotor housing through the case and is moved along with the rotor housing,
wherein the case comprises a first connection member, and the first connection member is connected with the rotor housing, and
wherein the first connection member is embedded into the rotor housing and is of interference fit with the rotor housing, or the first connection member is integrated with the rotor housing.

2-4. (canceled)

5. The gimbal according to claim 1, wherein the case further comprises a second connection member, the first connection member has a first accommodation cavity, the second connection member has a second accommodation cavity, the second connection member is connected with the first connection member so that the first accommodation cavity and the second accommodation cavity are combined to form an accommodation cavity for accommodating the imaging module.

6. The gimbal according to claim 5, wherein a side wall of the first connection member is disposed with a first opening, a side wall of the second connection member is disposed with a second opening at a position corresponding to the first opening, and the first opening and the second opening are combined to form a limiting hole for a lens of the imaging module to protrude.

7. The gimbal according to claim 6, wherein the limiting hole fixes the lens of the imaging module therein.

8. The gimbal according to claim 1, wherein an inner wall of the first connection member adjacent to the rotor housing defines a friction face, an end of the imaging module adjacent to the rotor housing defines an abutting face, and the abutting face is abutted against the friction face.

9. The gimbal according to claim 6, wherein the case further comprises a counterweight component for adjusting a gravity center of the imaging module.

10. The gimbal according to claim 9, wherein the counterweight component is a counterweight block received in the case.

11. The gimbal according to claim 10, wherein a side wall of the first connection member is disposed with a first receiving hole disposed at a position opposite to the first opening and extended along an axial direction of the first connection member, a side wall of the second connection member is disposed with a second receiving hole disposed at a position corresponding to the first receiving hole and extended along an axial direction of the second connection member, and the first receiving hole and the second receiving hole are combined to form a counterweight hole and the counterweight block is received in the counterweight hole.

12. The gimbal according to claim 5, wherein the first connection member is disposed with a first connection hole, the second connection member is disposed with a second connection hole at a position corresponding to the first connection hole, the first connection hole and the second connection hole are combined to form a connection hole and a connection structure is received in the connection hole.

13. The gimbal according to claim 1, further comprising a pitch motor, a yaw motor and a roll motor,
wherein the motor is the pitch motor, and
wherein an axis of the pitch motor, an axis of the roll motor and an axis of the yaw motor are perpendicular to each other, the pitch motor comprises a pitch rotor housing and a pitch stator and the pitch rotor housing is rotatably connected with the pitch stator, the yaw motor comprises a yaw rotor housing and a yaw stator and the yaw rotor housing is rotatably connected with the yaw stator, and the roll motor comprises a roll rotor housing and a roll stator and the roll rotor housing is rotatably connected with the roll stator.

14. The gimbal according to claim 13, wherein the yaw stator is connected with the roll rotor housing through a first connection arm, the pitch motor and the imaging module are connected with a lower side of the yaw rotor housing.

15. The gimbal according to claim 14, further comprising a first counterweight component and a second counterweight component,
wherein the second counterweight component is connected with the roll rotor housing through a second connection arm, the yaw motor and the second counterweight component are opposite to each other and are respectively disposed at opposite sides of the roll motor, the first counterweight component is disposed at an end of the case away from the pitch rotor housing, one end of the first counterweight component is fixedly connected with the yaw rotor housing and the other end of the first counterweight component is disposed with a rotation arm.

16. The gimbal according to claim 15, wherein the second counterweight component is disposed with an accommodation cavity and the rotation arm is extended into the accommodation cavity of the second counterweight component.

17. The gimbal according to claim 15, wherein the first connection arm and the second connection arm are disposed at opposite sides of the roll motor and are disposed on a same straight line.

18. A shooting apparatus, comprising the gimbal according to claim 1.

19. A gimbal, comprising a motor and an imaging module,
wherein the gimbal further comprises a case of the imaging module, the imaging module is received in the case, and the imaging module is connected with the motor through the case so that the case serves as a connection member, and
wherein the case further comprises a counterweight component for adjusting a gravity center of the imaging module.

20. A gimbal, comprising a motor and an imaging module,
wherein the gimbal further comprises a case of the imaging module, the imaging module is received in the case, and the imaging module is connected with the motor through the case so that the case serves as a connection member,
wherein the gimbal further comprises a pitch motor, a yaw motor and a roll motor, and the motor is the pitch motor,
wherein an axis of the pitch motor, an axis of the roll motor and an axis of the yaw motor are perpendicular to each other, the pitch motor comprises a pitch rotor housing and a pitch stator and the pitch rotor housing is rotatably connected with the pitch stator, the yaw motor comprises a yaw rotor housing and a yaw stator and the yaw rotor housing is rotatably connected with the yaw stator, and the roll motor comprises a roll rotor housing and a roll stator and the roll rotor housing is rotatably connected with the roll stator,
wherein the yaw stator is connected with the roll rotor housing through a first connection arm, the pitch motor and the imaging module are connected with a lower side of the yaw rotor housing,
wherein the gimbal further comprises a first counterweight component and a second counterweight component, and
wherein the second counterweight component is connected with the roll rotor housing through a second connection arm, the yaw motor and the second counterweight component are opposite to each other and are respectively disposed at opposite sides of the roll motor, the first counterweight component is disposed at an end of the case away from the pitch rotor housing, one end of the first counterweight component is fixedly connected with the yaw rotor housing and the other end of the first counterweight component is disposed with a rotation arm.

21. The gimbal according to claim 13, wherein for the pitch motor, the yaw motor and the roll motor, no motor is surrounded by another motor.

22. The gimbal according to claim 8, wherein the imaging module is prevented from rotating by a friction force between the friction face and the abutting face.

23. The gimbal according to claim 8, wherein a recess is disposed on the friction face and the end of the imaging module adjacent to the rotor housing is inserted into the recess.
